(19) United States
(12) Patent Application Publication
(10) Pub. No.: US 2005/0243073 A1
(43) Pub. Date: Nov. 3, 2005

(54) Presentation device and display method

(75) Inventors: Susumu Hashimoto, Mizuho-ku (JP); Mikihiro Kojima, Anjo (JP)

Correspondence Address: OSTROLENK FABER GERB & SOFFEN, 1180 AVENUE OF THE AMERICAS, NEW YORK, NY, 100368403, US

(73) Assignee: Elmo Company, Limited

(21) Appl. No.: 11/022,996

(22) Filed: Dec. 27, 2004

(30) Foreign Application Priority Data
Apr. 28, 2004 (JP) 2004-132668

(51) Int. Cl. G09G 5/00

(52) U.S. Cl. 345/184

(57) ABSTRACT

Upon certain operations by a user, the presentation device displays a zoom window ZW in an image. The user moves the zoom window ZW by moving a mouse 19, so as to indicate a desired area in the image. When the desired area is indicated by the user, the presentation device magnifies and displays the area in the zoom window ZW. The area H in the zoom window is displayed with relatively higher brightness than other areas. As a result, the presentation device of the invention allows the location of the magnified area to be readily indicated while previewed.

### BACKGROUND OF THE INVENTION

1. Field of the Invention

The invention relates to a presentation device for producing an image by projecting materials such as a document and samples with a camera, and displaying the images on an external display device.

2. Description of the Related Art

The presentation devices are used in the field or the like to give presentations. Most have a zoom function allowing materials projected by a camera to be magnified and displayed on a display device (such as Japanese Unexamined Patent Application 2002-281467A). In conventional zoom functions of this type, the magnified display is based on the position of a mouse cursor displayed on the display device or the center portion on the display device.

However, even though the zoom function in conventional presentation devices make it possible to learn beforehand a point of reference for magnified display that will result in the position of the mouse cursor or the central portion on the display device, it is difficult to specifically ascertain where the area that is actually magnified after the zooming operation is located in the image currently displayed on the display device.

### SUMMARY OF THE INVENTION

In view of the foregoing, an object of the present invention is to provide a presentation device which would allow the location of the magnified area to be readily indicated while previewed.

To address this object, the present invention is a presentation device for producing an image by projecting materials using a camera, and displaying the images on a connected display device, comprising: operation detecting unit that detects the operations of a pointing device; window display unit that moves according to the moving operations of the pointing device and allows a window for showing part of the area in the image to be displayed in the image; and magnifying display unit that, on the basis of certain operations, magnifies and displays the area shown in the window, which is the part of the area in the image projected by the camera and displayed on the display device.

The presentation device of the invention allows a window that moves according to the moving operation of a pointing device to be displayed in the image, and magnifies the area shown in the window. The user can thus readily indicate the location of the magnified area while viewing it. Various input devices such as a mouse, tablet, digitizer, tracking ball, joystick, or remote control with arrow keys can be used as the pointing device.

The presentation device with the aforementioned structure may further comprise cursor display unit that makes a cursor move according to the moving operations of the pointing device to be displayed on the image, wherein the window display unit displays a window based on the cursor position, in such a way that the relative position of the cursor in the coordinate system in the image and the relative position of the cursor in the coordinate system in the window are the same.

In this arrangement, the location in the image indicated by the cursor will not change before or after the image is magnified. The user can thus operate the pointing device without becoming disoriented after the image has been magnified. This arrangement is also more convenient to use because the area that is to be magnified can be indicated by indicating the cursor position in addition to the window.

The window display unit may display the window by increasing the brightness of the part of the area in the image. The window display unit may also display the window by lowering the brightness of the parts other than the part of the area in the image. This allows the part that will be magnified to be clearly distinguished from the other parts, making it easier to indicate the magnified part.

A variety of other embodiments can be adopted for the window display, not just these. For example, what is displayed inside the window and outside the window may be displayed in different colors, such as color display of the contents of the window and monochromatic or sepia tone display of the other areas. What is displayed inside the window and outside the window may also be displayed with different image processing, such as displaying the contents of the window with greater contrast and displaying the other parts with less focus. A certain rectangle can also be simply drawn on the image to display the window.

The magnifying display unit may magnify image data projected by the camera, so as to magnify and display the area shown in the window. This embodiment allows the image to be magnified at the proper magnification because the image is electronically magnified.

The camera in the presentation device having the aforementioned structure may comprise a zoom mechanism capable of optically magnifying and projecting the materials, wherein the magnifying display unit controls the zoom mechanism to magnify and project the area shown in the window, and displays the magnified projected image. This embodiment allows the image to be optically magnified, and can thus improve the quality of the magnified image.

The above embodiments of the invention can be adopted as desired in combination or in part. The invention can also be worked in the form of a magnifying display method for the magnified display of desired areas in an image on a presentation device, in the form of a computer program for executing such magnified display, or the like. The various embodiments described above can be applied to any arrangement. Computer programs may also be recorded on computer-readable media. Examples of recording media include floppy disks, CDs, DVDs, opticomagnetic disks, memory cards, and hard disks.

### BRIEF DESCRIPTION OF THE DRAWINGS

FIG. 1 illustrates the schematic structure of the material presentation device 10.

FIG. 2 illustrates an example of an image displayed on a display device 18.

FIG. 3 illustrates an example of the display on the zoom window.

FIG. 4 is a block diagram of the control circuit 100.

FIG. 5 is a flow chart of the magnification display process.

FIG. 6 illustrates a method for calculating coordinates in the zoom window ZW.

### DESCRIPTION OF THE PREFERRED EMBODIMENTS

Embodiments of the invention are illustrated in the following order based on examples.
A. Schematic Structure of Material Presentation Device
B. Internal Structure of Material Presentation Device
C. Magnified Display Process

### C. Other Embodiments

A. Schematic Structure of Material Presentation Device:

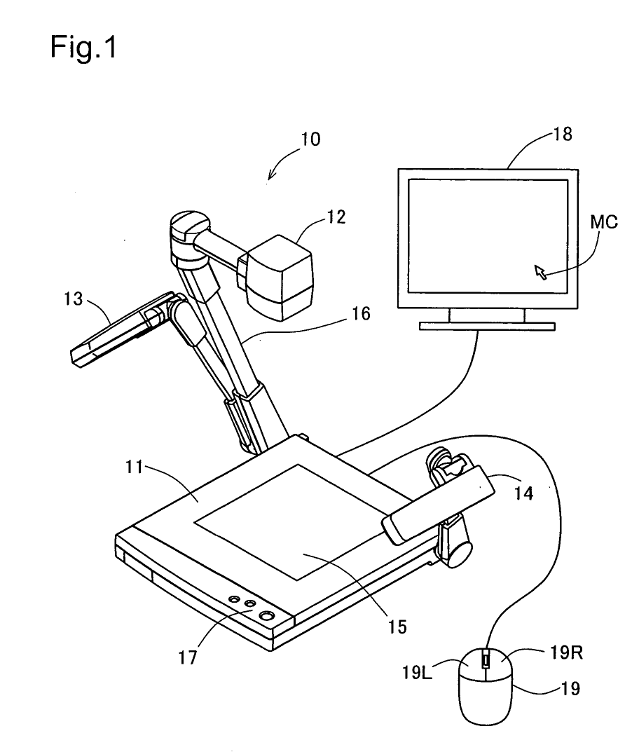

FIG. 1 illustrates the schematic structure of the material presentation device 10 as an example of the invention. The material presentation device 10 is made of a material holding stand 11, which accounts for most of the bottom, a camera head 12 facing the stand, and left and right lights 13 and 14, etc., illuminating the material holding stand 11 from above. The lights 13 and 14 are rotatably connected to the left and right rear ends of the material holding stand 11, and are used as needed during the projection of the materials on the material holding stand 11. The upper surface of the material holding stand 11 is made of a light-transmitting material, with a light 15 housed in the interior. The light 15 is used when a negative or the like placed on the material holding stand 11 is illuminated from below.

An operating panel 17 is provided at the front edge of the material holding stand 11. The operating panel 17 is equipped with various operating buttons, such as a power source button, buttons to turn the lights 13, 14, and 15 on and off, buttons to control the zoom or focus and iris with the camera head 12, and buttons for switching the destination of the image output.

The camera head 12 is supported by an arm 16 so as to face the center of the material holding stand 11, and projects the various types of materials placed on the stand 11. The camera head 12 comprises a CCD (charge-coupled device) and a focus lens or zoom lens for focusing light on the CCD, as well as an iris-adjusting mechanism for adjusting the iris or a control motor for moving the position of the lenses on the optical axis. The CCD converts the light focused through the lens to image signals, and outputs the image signals to the control circuit in the interior of the material holding stand 11. After various image processes such as frame rate conversion, the control circuit outputs the image signals to the display device 18 connected to the material presentation device 10. A CRT, liquid crystal display, projector, television, or the like can be used as the display device 18.

A mouse is connected as a pointing device to the material presentation device 10. The mouse 19 comprises a left button 19L and right button 19R. In the following description, pressing the left button 19L is referred to as “left click,” and pressing the right button 19R is referred to as “right click.” When the user moves the mouse 19, the mouse cursor MC that moves accordingly is displayed, on the display 18, superimposed over the image projected by the camera head 12. The user employs the mouse 19 for OSD (on-screen display) described below or to indicate the area that is to be magnified. In this example, the mouse 19 is connected as the pointing device, but the tablet, digitizer, tracking ball, joystick, or remote control with arrow keys can also be used as the pointing device.

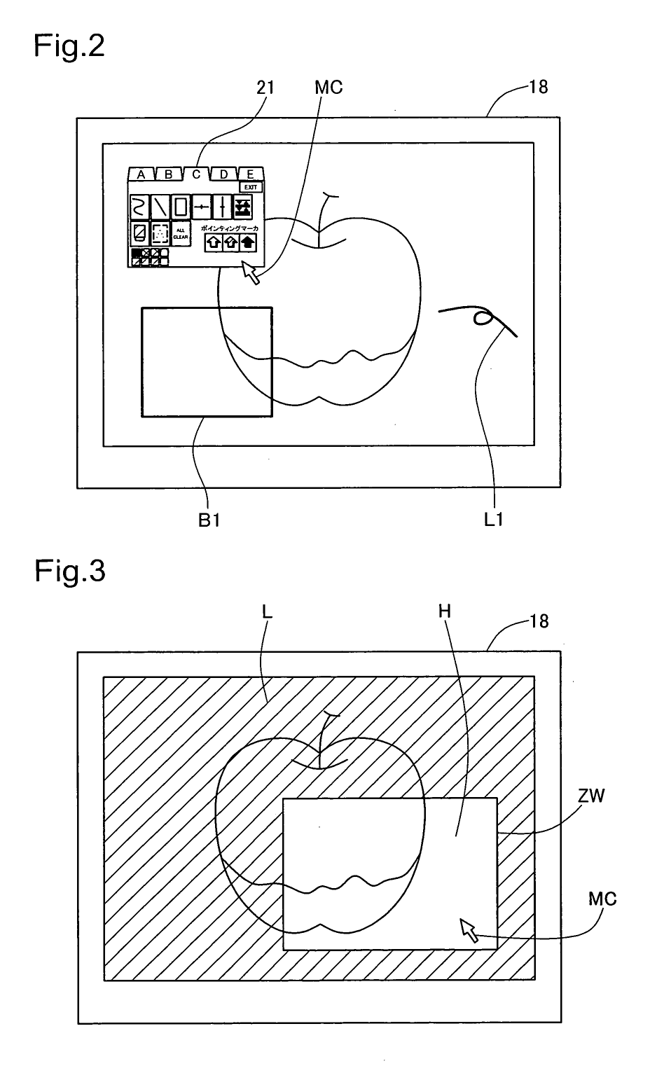

FIG. 2 illustrates an example of an image displayed by the material presentation device 10 on the display device 18. In this case, the image is of a projected apple. The image of the apple projected by the camera head 12 is displayed on the display 18, and the mouse cursor MC, OSD 21, or the like is displayed superimposed on the image.

The OSD 21 is a graphical user interface for various settings and operations of the material presentation device 10. The OSD 21 comprises a plurality of tabs A through E. A variety of operating buttons is disposed in each tab. The user can also employ the OSD 21 to draw various shapes such as a rectangle B1 or curve L1 on the screen, in addition to the above settings and operations.

FIG. 3 illustrates an example of the display on the zoom window for indicating the area that is to be magnified. The material presentation device 10 displays the zoom window zW illustrated in FIG. 3 in the image when the user performs certain operations. The user moves the zoom window ZW by moving the mouse 19 to indicate the desired area in the image. The area H in the zoom window ZW is displayed with relatively higher brightness than the other areas.

B. Internal Structure of Material Presentation Device

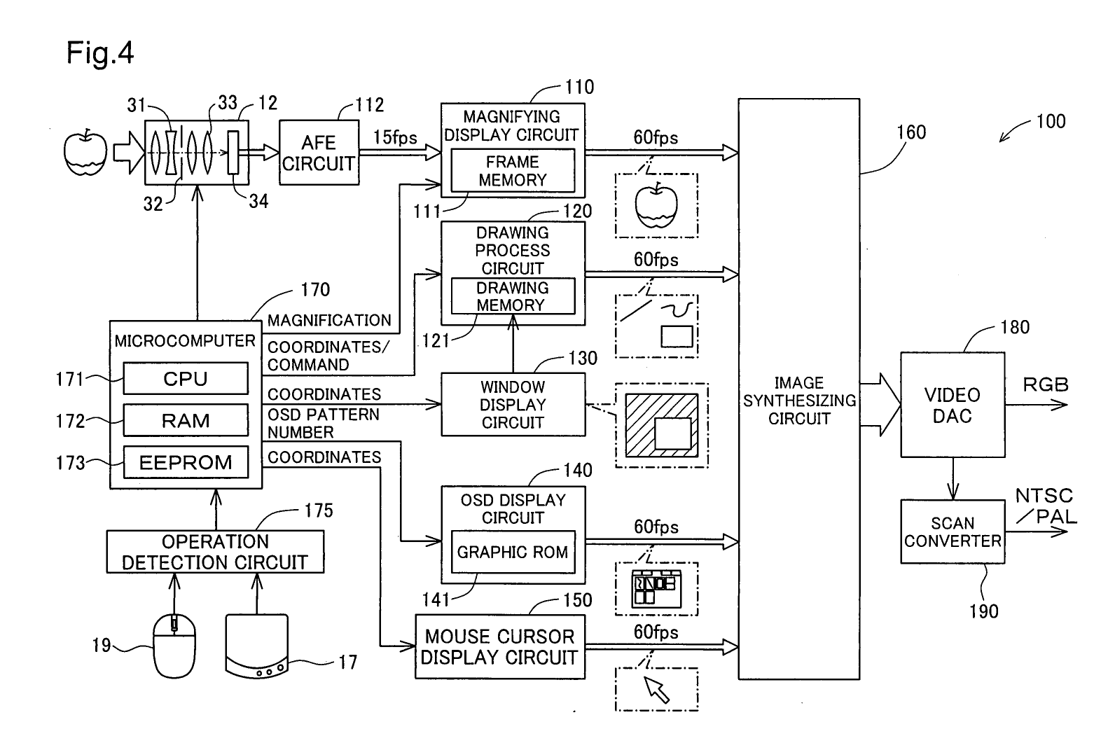

FIG. 4 is a block diagram of the control circuit 100 in the material presentation device 10. The control circuit 100 comprises a magnified display circuit 110 for the frame rate conversion or magnification of images input from the camera head 12, drawing process circuit 120 for drawing on the image, window display circuit 130 for displaying the zoom window ZW, OSD display circuit for displaying OSD 21, and mouse cursor display circuit 150 for displaying the mouse cursor MC, as well as an image synthesizing circuit 160 for synthesizing images output from the above circuits or a microcomputer 170 for controlling all operations of the material presentation device 10.

The microcomputer 170 comprises a CPU 171, RAM, 172, EEPROM 173, and the like. A program for controlling the circuits and camera head 12 is stored in EEPROM 173. The CPU 171 executes the program while using RAM 172 as a work area. The EEPROM 173 is used for applications in which various types of parameters set by the OSD 21 are stored in a nonvolatile manner.

The mouse 19 or operating panel 17 are connected through an operation detection circuit 175 to the microcomputer 170. The microcomputer 170 used the operation detection circuit 175 to determine how much the mouse 19 has moved. The microcomputer 170 sequentially adds the extent of movement to determine the coordinates on the image indicated by the mouse 19. The microcomputer 170 outputs the coordinate data that has been determined, click signals of the mouse 19, operation signals of the operating panel 17, or the like to the following various circuits as desired.

The magnification display circuit 110 inputs the image signals output from the camera head 12 through the AFE circuit 112 to perform frame rate conversion, magnified display, or various other types of image processes. The camera head 12 comprises a zoom lens 31, a plurality of lenses 32 including a focus lens 33, a CCD 34, and the like. The AFE circuit 112 is a circuit for converting analog signals output by the CCD 34 in the camera head 12 to digital signals.

The magnifying display circuit 110 sequentially inputs image signals output at a timing of 15 frames per second (15 fps) from the CCD 34 and stores them in frame memory 111. The image data is read from the frame memory at a timing of 60 frames per second (60 fps) and is output to the image synthesizing circuit 160. This allows the frame rate of images output from the CCD 34 to be converted to a frame rate suitable for display on the display 18. In this embodiment, the resolution of the images input from the CCD 34 is SXGA (1280 pixels×1024 pixels), and the resolution of the image output to the image synthesizing circuit 160 is also SXGA size.

The magnifying display circuit 110 functions to magnify images according to commands from the microcomputer 170. When the coordinates of the area that is to be magnified are input from the microcomputer 170, the magnifying display circuit 110 reads the image from the address area in the frame memory 111 corresponding to the coordinates. The image is magnified at the magnification rate stipulated by the microcomputer 170, and the magnified image is output to the image synthesizing circuit 160. When the image is magnified, interpolation is done by a well known method such as the nearest neighbor method, pi linear method, or pi cubic method.

The drawing process circuit 120 draws various figures such as lines and curves in drawing memory 121 according to the coordinate data and the like produced and output by the microcomputer 170 with the movement of the mouse 19 or drawing commands output by the microcomputer 170. Images drawn in the drawing memory 121 are output to the image synthesizing circuit 160 at a timing (60 fps) synchronized with the image output by the magnifying display circuit 110 described above.

The window display circuit 130 displays the zoom window ZW shown in FIG. 3 in the image. The window display circuit 130 receives a command for the coordinates showing the zoom window ZW from the microcomputer 170, and produces an image showing the zoom window ZW according to the coordinates. The resulting image is drawn to the drawing memory 121 described above. The image showing the zoom window ZW is formed of a highlighted part (part indicated by H in FIG. 3) and other parts (part indicated by L in FIG. 3). The highlighted part is formed by signals increasing the brightness of the image, and the other parts are formed by signals lowering the brightness.

The OSD display circuit 140 comprises graphic ROM 141 storing various types of graphic data showing the OSD. The OSD display circuit 140 reads graphic data for the indicated pattern from the graphic ROM upon receiving a command for the pattern of the OSD for display from the microcomputer 170. The graphic data and certain coordinates for displaying the graphic data are output to the image synthesizing circuit 160 at a timing (60 fps) synchronized with the magnifying display circuit 110.

The mouse cursor display circuit 150 produces an image of 32 dots×32 dots showing the mouse cursor MC in the color and shape indicated upon the input of coordinate data and signals for indicating the color and shape of the mouse cursor MC from the microcomputer 170. The image and the coordinates input from the microcomputer 170 are then output to the image synthesizing circuit 160 at a timing (60 fps) synchronized with the magnifying display circuit 110.

The image synthesizing circuit 160 synthesizes the image output from the circuits described above. When the synthesized coordinates are indicated, the synthesis is done according to those coordinates. The synthesizing priority is given below in order of ascending priority.
(1) image output from the magnifying display circuit 110
(2) image output from drawing process circuit 120
(3) image output from OSD display circuit 140
(4) image output from mouse cursor display circuit 150

Figures drawn in the drawing memory 121, the ODS, and the mouse cursor MC are displayed superimposed according to this order on the image projected by the camera head 12.

During the synthesis process, when the image output from the drawing process circuit 120 includes signals increasing or lowering the brightness, that is, an image showing the zoom window ZW, the image synthesizing circuit 160 adjusts the brightness of the pixels in the image input from the magnifying display circuit 110 based on the signals. Because RGB values from 0 to 255 for each pixel forming the image are output from the magnifying display circuit 110, a process is performed for adding 64 across the board to the pixel values of each RGB color, where 255 is the maximum, when the brightness is increased. When the brightness is lowered, a process is performed for subtracting 64 across the board from the pixel values of each RGB color, where 0 is the minimum value. Even if the image to be magnified is virtually a single black or white color, for example, this embodiment permits display with better visibility, without the zoom window ZW being set up in the image. In this example, the brightness in the zoom window ZW was increased, and the brightness of the other parts was lowered, but the brightness in the zoom window may be increased while the brightness of the other parts is not changed. The brightness in the zoom window Zw may also be left unchanged while the brightness of the other parts is lowered.

The image synthesized by the image synthesizing circuit 160 is output to a video DAC 180. The video DAC 180 converts the digital signal output from the image synthesizing circuit 160 to analog RGB signals. The analog RGB signals converted by the video DAC 180 are used when the image is displayed on a liquid crystal display, CRT, projector, or the like.

The analog RGB signals output from the video DAC 180 is further converted down by a scan converter 190, and is converted to NTSC signals or PAL signals. These signals are used when outputting the image to television or video.

C. Magnified Display Process

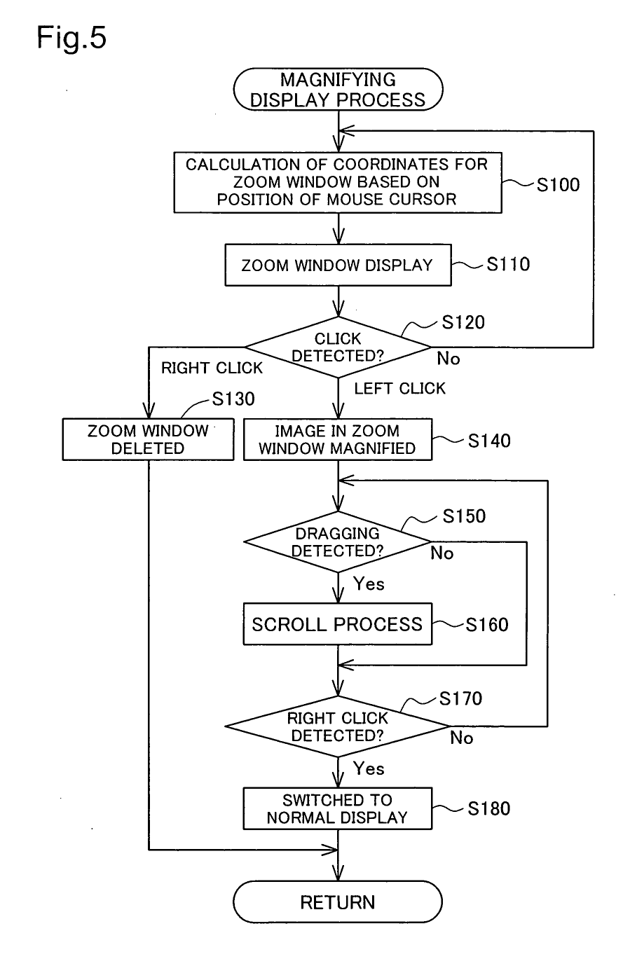

FIG. 5 is used to illustrate the process for the magnified display of imaged projected by the camera head 12. FIG. 5 is a flow chart of the magnified display process run by the microcomputer 170. This process is run when the mouse 19 is right clicked while the mouse cursor MC is displayed on the screen.

The microcomputer 170 first calculates the coordinates displaying the zoom window ZW based on the display position of the mouse cursor MC (Step S100). The coordinates are determined so that the relative position of the mouse cursor MC in the entire coordinate system of the screen and the relative position of the mouse cursor MC in the coordinate system in the zoom window ZW are the same. Specifically, they are calculated in the following manner.

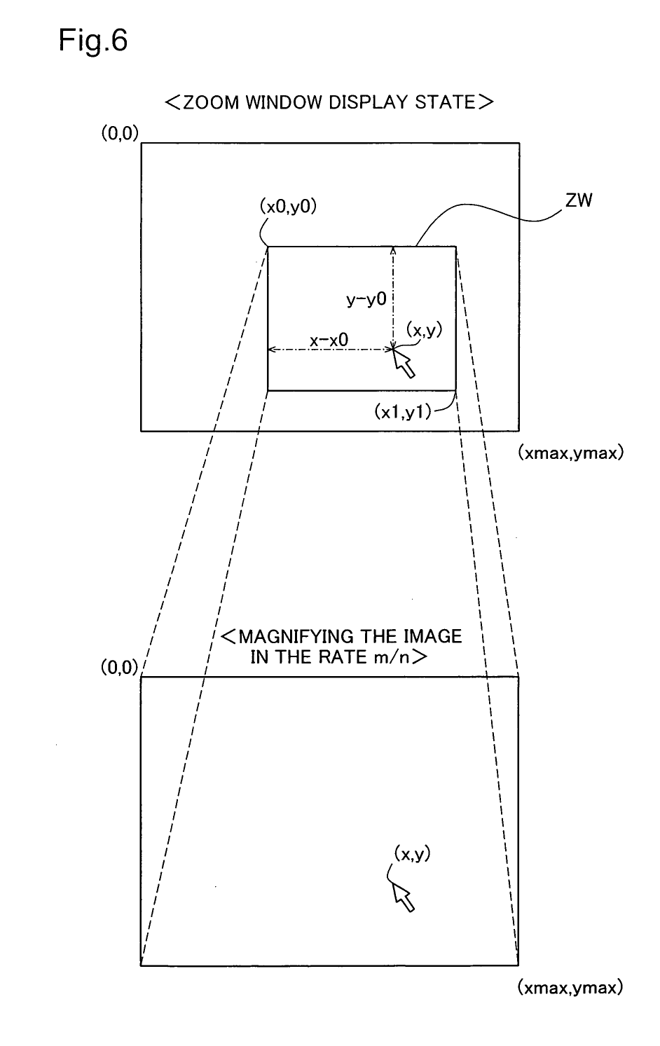

FIG. 6 illustrates a method for calculating coordinates displaying the zoom window ZW. In this case, as illustrated in FIG. 6, the starting points of the coordinates for the screen are (0,0), and the maximum is (xmax, ymax). The coordinates at the apex of the upper left corner of the zoom window ZW are (x0,y0), and the coordinates at the apex of the lower right corner are (x1,y1). The coordinates for the mouse cursor MC are (x,y). The magnification rate of the image already displayed on the display 18 is n, and the magnification rate of the magnified image is m. That is, the actual magnification rate of the magnified image is m/n. Although the magnification rates n and m can be set as desired, in this example, the magnification rate n is 1, and the magnification rate m is 2.

A method for determining the upper left corner coordinates (x0,y0) in the zoom window ZW is described first. In this case, in consideration of the coordinate system in the zoom window ZW, the coordinates for the mouse cursor MC can be expressed as (x−x0,y−y0), assuming coordinates (x0,y0) as starting points.

When the coordinates for the mouse cursor MC in the magnified image are (X,Y), the coordinates (X,Y) can be expressed by the following Equations (1) and (2) because they are the coordinates for the mouse cursor MC (x−x0,y−y0) in the coordinate system in the zoom window ZW times (m/n).
X=(x−x0)×(m/n) (1)
X=(y−y0)×(m/n) (2)

To allow the mouse 19 to be operated without becoming disoriented, the mouse cursor MC display position does not change before and after the image is magnified. Thus, X=x, and Y=y. Transformation of Equations (1) and (2) based on these conditions allows the coordinates (x0,y0) of the upper left corner of the zoom window ZW to be expressed as shown in Equations (3) and (4) below.
x0=(1−n/m)x (3)
y0=(1−n/m)y (4)

A method for determining the coordinates (x1,y1) for the lower right corner of the zoom window ZW is described next. Because the image in which the width and height of the zoom window ZW are multiplied (m/n) is displayed on the entire screen after magnification, the maximum coordinate values (xmax,ymax) can be expressed as shown in Equations (5) and (6).
xmax=(x1−x0)×(m/n) (5)
ymax=(y1−u0)×(m/n) (6)

Transformation substituting Equations (5) and (6) for Equations (3) and (4) allows the lower right corner coordinates (x1,y1) of the zoom window ZW to be expressed as shown in Equations (7) and (8) below.
x1=(n/m)×xmax+(1−n/m)x (7)
y1=(n/m)×ymax+(1−n/m)y (8)

The microcomputer 170 can use Equations (3), (4), (5), (6), (7), and (8) to calculate the coordinates for displaying the zoom window ZW. In this method of calculation, the mouse cursor MC indicates the same position in the image before and after the image is magnified.

When, for example, the mouse cursor MC is displayed at coordinates (xmax,ymax), the coordinates of the lower right corner of the zoom window ZW will also be (xmay,ymax) according to Equations (7) and (8). Thus, according to the method of calculation described above, the zoom window ZW can be displayed without running ove5 the edges of the screen.

Returning to FIG. 5, when the microcomputer 170 calculates the coordinates displaying the zoom window ZW by means of the above equations, the coordinate data is output to the window display circuit 130, and the zoom window ZW is displayed (Step S110).

Next, the microcomputer 170 detects whether or not the mouse 19 has been clicked (Step S120). When no click operation has been detected (Step S120: No), the routine moves to the process in Step S100 above. With this, the zoom window ZW moves with the movement of the mouse 19. When a right click is detected (Step S120: right click), it is determined that the magnified display process has been cancelled, and the zoom window ZW is deleted (Step S130), ending the process.

When a left click is detected (Step S120: left click), the microcomputer 170 magnifies and displays the area in the zoom window ZW by outputting the magnification rates n and m as well as the coordinate data calculated in Step S110 to the magnifying display circuit 110 (Step S140). In the magnifying display circuit 110, the magnification process is run in real time on the image projected by the camera head 12. Thus when the material on the material holding stand 11 is moved, the magnified image displayed on the display 18 also moves. In this example, the image is thus magnified in real time, but images can also be stored fixed in frame memory 111 and displayed as still pictures, and these still pictures may also be magnified and displayed.

After the area in the zoom window ZW has been magnified, the microcomputer 170 detects whether or not the mouse 19 is being dragged (Step S150). When dragged, a process is run to scroll the magnified image according to the movement of the mouse 19 (Step S160). The scroll display allows the area being displayed to be moved even after the image has been magnified.

After the scroll process in Step S170, or when no dragging operation has been detected in Step S160, the microcomputer 170 is right clicked (Step S170). When right clicked (Step S170: Yes), it is determined that the magnified display has been completed, the magnifying display circuit 110 is controlled to switch the image display state to the normal unmagnified state, and the process is complete (Step S180). When no right click is detected (Step S170: No), the routine moves to Step S150 for magnified display.

As noted above, in this process, the magnification rate n is 1, and the magnification rate 2 is 2, but they may be set to any value. For example, when separate means are provided for digitally zooming the image based on the center of the screen without the use of the zoom window ZW, the magnification rate n can be adjusted in several steps from 1 to 2. When the magnification rate n is thus adjusted according to Equations (3), (4), (7), and (8), the size of the zoom window ZW changes according to the value. Specifically, when the magnification rate n is fixed at 2, the size of the zoom window ZW on the screen expands to the entire screen as the magnification rate n approaches 2. The magnification rate m as well as n can be adjusted by the rotation of the wheel in the mouse 19, for example.

The material presentation device 10 structure and process were described in the above example. The material presentation device 10 in this example displayed a zoom window ZW on-screen that moved with the movement of the mouse 19 before the image was magnified. The user can thus easily indicate the position of the area to be magnified while previewing it in the zoom window ZW. In this example, the mouse cursor MC indicated the same position in the image before and after the image was magnified, allowing the use to operate the mouse 19 without becoming disoriented after the image was magnified. In this example, the brightness of the image in the zoom window ZW was increased, allowing the magnified area to be readily discerned.

In this example, when the image was magnified and displayed, the data of the image projected by the camera head 12 was magnified by the magnifying display circuit 110. However, magnified display can be done by using a zoom lens 31 instead of the magnifying display circuit 110 to magnify and project the material. In such cases, a mechanism capable of modifying the projection position of the camera head 12 is provided. The microcomputer 170 controls the position of the zoom lens 31 on the optical axis and the projection position of the camera head 12 to project the area indicated by the zoom window ZW. This arrangement allows the image quality of the magnified image to be improved because the material can be optically magnified and projected. Examples of mechanisms capable of modifying the projection position include those for moving the arm supporting the camera head 12, and those modifying the angle of projection of the camera head 12.

In this example, the zoom window ZW was displayed with parts of the image having higher and lower brightness as illustrated in FIG. 3. However, the embodiment of the zoom window ZW is not limited to this. The contents of the zoom window ZW may be displayed in color, for example, while the other areas are displayed monochromatically or in sepia tones, etc. The contents of the zoom window ZW may also be displayed with greater contrast while the other parts are displayed with less focus. A certain rectangular frame can also be simply drawn to display the zoom window ZW. The rectangular frame may be drawn with straight lines, or with dashed lines. The frame may be any size or color. The color of the frame may be changed according to the hue of the image, for example.

In this example, when the zoom window ZW is displayed, the mouse cursor MC is also always displayed simultaneously, but the mouse cursor MC may also be left out. In such cases, the zoom window ZW should move with the movement of the mouse 19.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

1. A presentation device allowing images, that have been obtained upon the projection of materials by a camera, to be displayed on a connected display device, the presentation device comprising:
a pointing device for indicating locations;
operation detecting unit that detects the pointing device operations;
window display unit that moves according to the moving operations of the pointing device and allows a window for showing part of the area in the image to be displayed in the image; and
magnifying display unit that, on the basis of certain operations, magnifies and displays the area shown in the window, which is the part of the area in the image projected by the camera and displayed on the display device.

2. A presentation device according to claim 1, further comprising:
cursor display unit that makes a cursor move according to the moving operations of the pointing device to be displayed on the image, wherein
the window display unit displays a window based on the cursor position, in such a way that the relative position of the cursor in the coordinate system in the image and the relative position of the cursor in the coordinate system in the window are the same.

3. A presentation device according to claim 1 or 2, wherein:
the window display unit displays the window by increasing the brightness of the part of the area in the image.

4. A presentation device according to claim 1, wherein the window display unit displays the window by lowering the brightness of the parts other than the part of the area in the image.

5. A presentation device according to claim 1, wherein the magnifying display unit magnifies image data projected by the camera, so as to magnify and display the area shown in the window.

6. A presentation device according to claim 1, wherein
the camera comprises a zoom mechanism capable of optically magnifying and projecting the materials, wherein
the magnifying display unit controls the zoom mechanism to magnify and project the area shown in the window, and displays the magnified projected image.

7. A magnifying display method for projecting materials on a presentation device comprising a camera, the method comprising the steps of:
producing images by projecting materials using the camera;
displaying the images on a connected display device;
detecting the operation of a pointing device for indicating locations;
displaying in the image a window that moves with the moving operation of the pointing device and shows a part of the area in the image; and
using certain operations to magnify and display the area shown in the window, which is the part of the area in the image projected by the camera and displayed on the display device.
